(19) United States
(12) Patent Application Publication
(10) Pub. No.: US 2005/0203810 A1
(43) Pub. Date: Sep. 15, 2005

(54) Demo-supermarket

(75) Inventor: Ziva Listenberg, Zur Hadassah (IL)

Correspondence Address: DR. MARK FRIEDMAN LTD.;C/o Bill Polkinghorn, Discovery Dispatch, 9003 Florin Way, Upper Marlboro, MD, 20772, US

(73) Assignee: D.D.S DEMO-DIGITAL SHOPPING LTD.

(21) Appl. No.: 10/796,960

(22) Filed: Mar. 11, 2004

(51) Int. Cl. G06F 17/60

(52) U.S. Cl. 705/27

(57) ABSTRACT

A shopping system for consumable items including: (a) a display module including a plurality of display items, wherein each of the display items is not itself available for purchase but visually represents a corresponding one of the consumable items available for purchase, wherein purchase codes associate the display items to the respective consumable items, and the purchase codes are collected by a customer; (b) a customer-operated shopping list assembly system operative to assemble a shopping list corresponding to purchase items the customer wishes to purchase and a quantity for each of the purchase items; (c) a service point that receives the shopping list with delivery instructions from the customer; and (d) a warehouse and packing facility that stores the consumable items and on receipt of the shopping list from the service point, packs and arranges delivery of the consumable items according to the shopping list and the instructions.

### FIELD AND BACKGROUND OF THE INVENTION

The present invention relates to shopping systems and, more particularly, to a supermarket that includes only demonstration items not for purchase. In a demo-supermarket of the present invention, customers base their purchases on the demonstration items and corresponding purchased items are packed in and delivered from an associated warehouse and packing facility.

The conventional way to shop for products of daily consumption is to stroll through a store and look for items of interest. The customer loads these items in a shopping cart, pushes the shopping cart to a checkout counter, and waits for his/her turn. After unloading at a checkout counter, the customer proceeds to pay for the purchased items, packs them, reloads the shopping cart, wheels the shopping cart to a motor vehicle for transportation to his/her home or apartment.

From the point of view of a typical customer, a major problem with shopping is the time consumption generally associated with crowds of shoppers and long lines at the checkout counters. Many customers are willing to pay a premium price or shop at an inconvenient time to avoid crowds and long lines. For many customers such as those who do not travel by car, elderly people or those with physical handicaps, shopping in a conventional store is very difficult.

Some supermarket chains provide an Internet service allowing customers to shop virtually “on line”. Some computer literate customers choose to shop using the Internet to avoid the shortcomings of conventional supermarket shopping. However, most customers prefer to see in real life the items they are purchasing, perhaps even taste, feel or smell certain items to be sure of their purchase.

From the point of view of the owners of supermarkets and supermarket chains, there are many difficulties associated with the daily management of a conventional supermarket. Each branch of a supermarket chain is required to maintain inventory on a daily basis. A missing item of a popular brand translates into an immediate loss of direct sales as well as a potential loss of future sales. A customer will often choose to shop the following week at a competing supermarket to stock up on an item missing from the store he/she had shopped at previously.

On the other hand, overstocking of items in a conventional supermarket is not possible, since the excess stock requires additional storage space that is not available. Furthermore, frozen foods cannot be overstocked because of limited space in deep freeze rooms and other refrigerated compartments. Produce and baked goods have a finite shelf life, therefore; overstocking of these items is wasteful.

The interior floor space required for a conventional supermarket is considerable. Most of the merchandise for sale in the supermarket is placed on large freestanding shelves situated in rows. The use of shopping carts in a conventional supermarket requires that the aisles between the rows of shelves are sufficiently wide for at least two shopping carts to pass each other comfortably. Many checkout counters are required to minimize customers' waiting time during peak shopping hours. During off peak hours most of the checkout counters are unused. The unused checkout counters during most of the day are an inefficient use of valuable interior floor space.

Outside the conventional supermarket, a significant area is often allocated for loading customers' vehicles in the front of the supermarket. In the back of a conventional supermarket, an area is also required for trucks to unload merchandise at a loading clock. Shopping carts require storage either inside the supermarket or outdoors with a shelter to protect them from exposure to the weather. A conventional supermarket needs to provide convenient parking for its customers.

For these and other reasons, the interior floor space required for a conventional supermarket varies between 400-1000 square meters. As a result, the rental cost for a conventional modern supermarket is prohibitive in many urban neighborhoods and commercial centers and therefore large supermarkets are not located in expensive residential neighborhoods and commercial areas.

The personnel requirements of a conventional supermarket are a significant cost. Employees are required to arrange merchandise on the shelves in an organized and attractive way. Supermarket staff marks all the items individually with price labels, as required according to local regulations. Produce and baked goods departments each require a daily turnover of merchandise. Many cashiers are required for checkout especially at peak shopping times.

The constant flow of merchandise and customers in and out of a conventional supermarket generates debris so that a conventional supermarket requires cleaning more than once a day. A “dirty supermarket” repels customers.

Shoplifting is a considerable loss of revenue to conventional supermarkets in many regions. Most supermarkets hire a security staff to insure that merchandise that was not paid for does not leave the supermarket.

There is considerable prior art in the field shopping systems and methods dealing with electronically gathering product information and/or electronic payment. The following references are exemplary of the most closely related prior all.

U.S. patent application 2003/0197061 entitled, “Shopping System”, is directed towards providing an electronic shopping system that uses a sales and payment processor to conduct cashless shopping and merchandising in stores and avoids the risk with respect to cash transactions. All transactions are settled on a cashless basis with sales and payment processors that are respectively installed at checkout counters and in automatic vending machines.

U.S. patent application 2003/0195818, entitled “Portable Sales Assistant Terminal System”, is related to portable terminals. Each portable terminal incorporates a scanning unit for acquiring product information. The system further includes a wireless communications network for receiving product information from a central host facility.

U.S. patent application 2001/0051903, entitled “Personal Digital Shopping Trolley” relates to computer aided shopping systems. A mobile computing device is disclosed having an interface to a product data source so that a customer can gather relevant product information.

These representative disclosures relate to shopping in a conventional store, i.e., where the items to be purchased are arranged on display and collected directly by the customer.

In the field of non-consumable goods, and particularly for large and/or valuable items such as furniture, large electrical appliances, cars and jewelry, it is common to employ a showroom of items not for sale and then, after payment, arrange delivery of the goods. Such an approach is a natural result of the nature of the goods for sale, and has not hitherto been used for consumable goods.

There is thus a need for, and it would be highly advantageous to have, a demo-supermarket in which customers base their purchases on demonstration items only and corresponding purchased items are packed in and delivered from an associated warehouse and packing facility. A demo-supermarket, of the present invention, has minimal space and staff requirements compared with a conventional supermarket. A demo-supermarket, of the present invention, is designed therefore to optimize customer satisfaction by moving most of the operations and logistics functions of the conventional supermarket to another location.

### SUMMARY OF THE INVENTION

According to the present invention there is provided, a shopping system for consumable items including: (a) at least one display module including a plurality of display items, wherein each of the display items is not itself available for purchase but visually represents a corresponding one of the consumable items available for purchase, wherein purchase codes associate the display items to the respective consumable items, wherein the purchase codes are collected by a customer; (b) a customer-operated shopping list assembly system operative to assemble a shopping list corresponding to purchase items the customer wishes to purchase and a quantity for each of the purchase items; (c) a service point that receives the shopping list with delivery instructions from the customer; and (d) a warehouse and packing facility that stores the consumable items and on receipt of the shopping list from the service point, packs and arranges delivery of the consumable items according to the shopping list and the instructions. Preferably, the display module has a horizontal depth of less than 50 cm. The display item is a sample item substantially identical to the corresponding one of the consumable items available for purchase or the display item is a replica visually representing the corresponding one of the consumable items available for purchase or the display item is an original package with at least a portion of the contents removed. The shopping system, further includes (e) a booth for providing a service such as product promotion and/or customer recreation; and (f) a resource area for providing services to the customer.

According to the present invention there is provided, a shopping system for consumable items including: (a) a plurality of display items, wherein each of the display items is not itself available for purchase but visually represents a corresponding one of the consumable items available for purchase, wherein purchase codes associate the display items to the respective consumable items available for purchase; (b) an information storage device used by customers for retrieving the purchase codes to create respective shopping lists and for giving the shopping lists with delivery instructions to a service point; and (c) a warehouse and packing facility that stores the consumable items and on receipt of the shopping lists and the instructions from the service point, packs and arranges delivery of the consumable items, according to the customers' respective shopping lists and the delivery instructions. Preferably, the information storage device further includes a wireless mechanism for retrieving the purchase codes. More preferably, the information storage device includes a bar code scanner for retrieving purchase codes.

According to the present invention there is provided, a display module, in a shopping system, for displaying items to customers including: (a) a plurality of display items for viewing by the customers, wherein each of the display items is not itself available for purchase but visually represents one consumable item available for purchase; and (b) a security mechanism that connects the display items to the display module permitting the customers to handle the display items but preventing the customers from removing the items from the display module. Preferably, the display module further includes: (c) a display screen for conveying information to the customers. Preferably, the security mechanism includes a wire for preventing the customers from removing the items from the display module.

According to the present invention there is provided a method for selling consumable items, comprising the steps of: (a) showing display items to a customer, wherein each of the display items is not itself available for purchase but visually represents a corresponding one of the consumable items available for purchase, the display items having purchase codes associated respectively with the consumable items; (b) receiving a shopping list and delivery instructions from the customer, the shopping list being created by collecting a plurality of the purchase codes from a plurality of the consumable items; (c) transferring the shopping list and the instructions to a warehouse and packing facility including the consumable items; and (d) packing purchased items according to the shopping list for delivery according to the instructions. Preferably, the collecting of purchase codes is performed using a bar code scanner. Preferably, the method includes (e) receiving a new variety of the consumable items into the warehouse and packing facility; and (f) updating the display items to represent the new variety.

### BRIEF DESCRIPTION OF THE DRAWINGS

The invention is herein described, by way of example only, with reference to the accompanying drawings, wherein:

FIG. 1 is a prior art drawing of a floor plan of a conventional supermarket;

FIG. 2 is a prior art drawing of a freestanding shelf unit of a conventional supermarket;

FIG. 3 is floor plan of a demo-supermarket according to the present invention;

FIG. 4 is a drawing of a display module as part of a demo-supermarket according to an embodiment of the present invention;

FIG. 5 is a drawing in perspective of a display module in a demo-supermarket, according to an embodiment of the present invention; and

FIG. 6 is a drawing of a node in a shopping network, according to an embodiment of the present invention.

### DESCRIPTION OF THE PREFERRED EMBODIMENTS

In a demo-supermarket of the present invention, customers base their purchases on demonstration items and/or sample items that are on display but are not for purchase. Specifically, the present invention separates two major functions of a conventional supermarket into two entities. The first entity is the demo-supermarket in which customers arrange their purchase. The second entity is a warehouse and packing facility where the customers' orders are packed and prepared for delivery. The separation of these functions into separate entities relieves the demo-supermarket of the operational constraints associated with a conventional supermarket and therefore the demo-supermarket is designed to optimize customer satisfaction. The warehouse and packing facility which is associated with one or more demo-supermarkets; is preferably optimized for operational efficiency without regard to visual presentation or customer accessibility because the warehouse and packing facility does not receive customers. The term “warehouse and packing facility” is defined herein as an area off limits to customers in which goods for purchase are stored, prepared and packed for delivery.

The principles and operation of a demo-supermarket according to the present invention may be better understood with reference to the drawings and the accompanying description.

It should be noted that the discussion herein relates to a shopping system with merchandise associated with a conventional supermarket as a non-limiting example.

This merchandise includes consumables and disposables such as food items, cleaning supplies, pet supplies, paper and plastic goods, and products for personal hygiene. The present invention may also be configured, as an alternative or in addition, with merchandise associated with a large conventional pharmacy. The merchandise associated with a pharmacy includes over the counter medicines, medical supplies, dietary supplements, perfumes, lotions and other health supplies. The present invention may also be configured, as an alternative or in addition, with merchandise associated with an office supplies store, including paper, pens, pencils, notebooks, ink and other office supplies. The term “consumable” as defined herein refers to goods that are eaten, are used up, have limited shelf life or are perishable.

A demonstration item is an item on display representing an item available for purchase. The demonstration item itself is not available for purchase. In an embodiment of the present invention, the demonstration item is a sample item. A sample item is an item not for sale that is identical with a purchase item, e.g. a box of Kellogg's Corn Flakes. Alternatively, a demonstration item is a replica representing a real item, e.g. artificial flower, Alternatively, a demonstration item is a package of a sample item with at least a portion of the contents removed, e.g. an empty box of Kellogg's Corn Flakes. The terms “demonstration item” and “display item” are used herein interchangeably.

Before explaining embodiments of the invention in detail, it is to be understood that the invention is not limited in its application to the details of construction and the arrangement of the components set forth in the following description or illustrated in the drawings. Specifically, the embodiments of the invention include details of an interior design of a demo-supermarket that are not intended to be limiting. The invention is capable of other embodiments or of being practiced or carried out in various ways. Also, it is to be understood that the phraseology and terminology employed herein is for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

By way of introduction, two principle intentions of the present invention are to: (1) provide a pleasant and efficient shopping experience to the customer and (2) provide an efficient shopping system with reduced operations and logistics costs.

The warehouse and packing facility, according to an embodiment of the present invention, is associated with several demo-supermarkets situated in a single urban area. The warehouse and packing facility receives merchandise, maintains inventory, packs and delivers to the customers of all the associated demo-supermarkets. The storage of goods only at a central warehouse and packing facility allows the individual demo-supermarkets to be small. There is consequently an overall savings in rental and utilities costs.

In an embodiment of the present invention, many of the operational problems of managing conventional supermarket are mitigated. Inventory management is centralized, and each supplier transports merchandise and/or produce to a single location only. There is no requirement for individual price labeling in the warehouse as there is in a conventional supermarket.

In an embodiment of the present invention, since the goods are stored at a single location at a warehouse and packing facility serving multiple demo-supermarkets; inventory management is simplified and therefore there is minimal monetary loss due to exceeding the shelf life of perishable items. Similarly, there is little loss of goods due to workers' eating or customer damage. Security requirements against shoplifting are removed because customers have no direct access to stock.

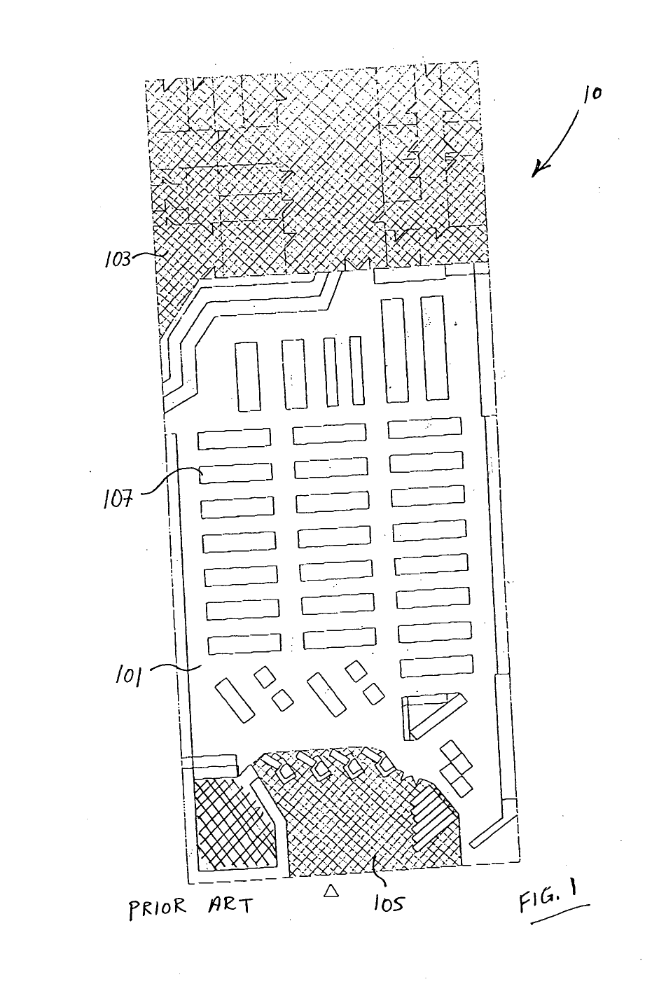

Referring now to the drawings, FIG. 1 is a floor plan of a prior art conventional supermarket 10. In conventional supermarket 10, a customer area 101 includes rows of shelf units 107. Behind customer area 101 is a service area 103 including refrigerators, deep freezers, preparation rooms and other storage. The front of conventional supermarket 10 is a checkout area 105 devoted to checkout, packing and storage of shopping carts. Service area 103 and checkout area 105 are both crosshatched, indicating operations area not useable for displaying goods totaling about one third of the area of conventional supermarket 10. The term “operations area” is defined herein as the floor area not useable for displaying goods for sale.

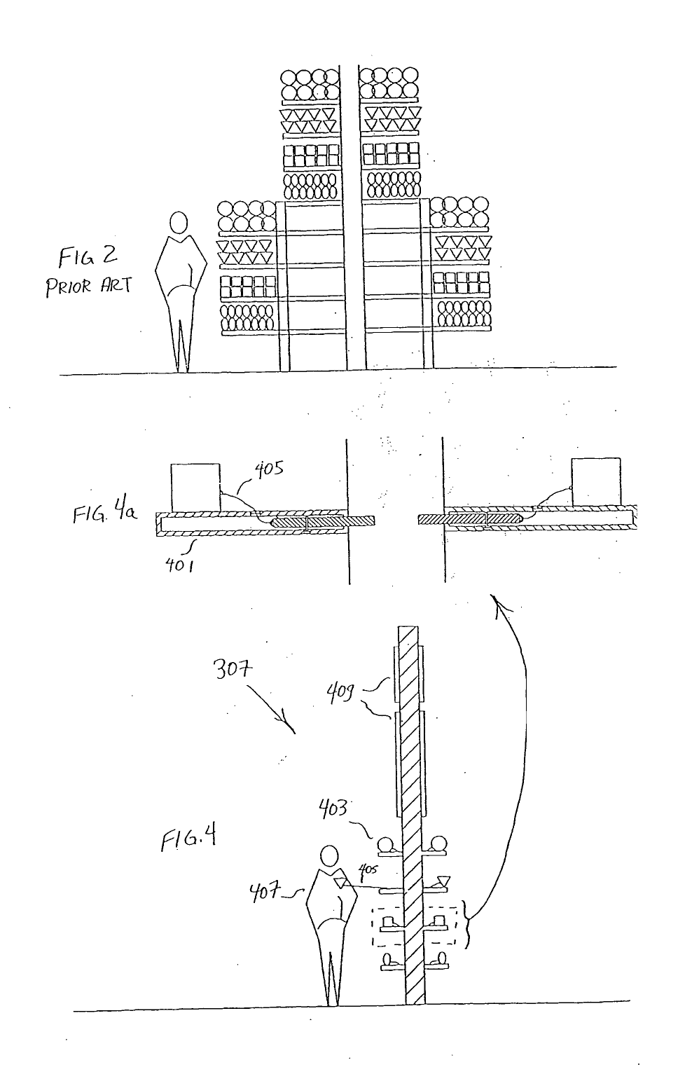

Referring now to FIG. 2 showing a prior art shelf unit 12 of conventional supermarket 10. Shelf unit 107 includes multiple shelves 201 each item holding a number of items 203 for purchase. In order to hold a significant number of items 203 for purchase, shelves 201 are relatively wide of width about 60 cm. Consequently, shelf units 107 require considerable floor space in conventional supermarket 10.

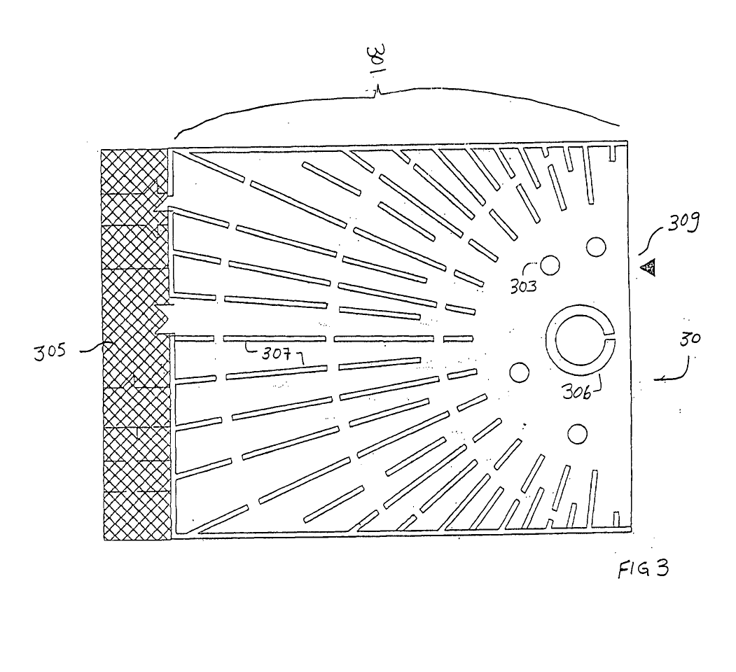

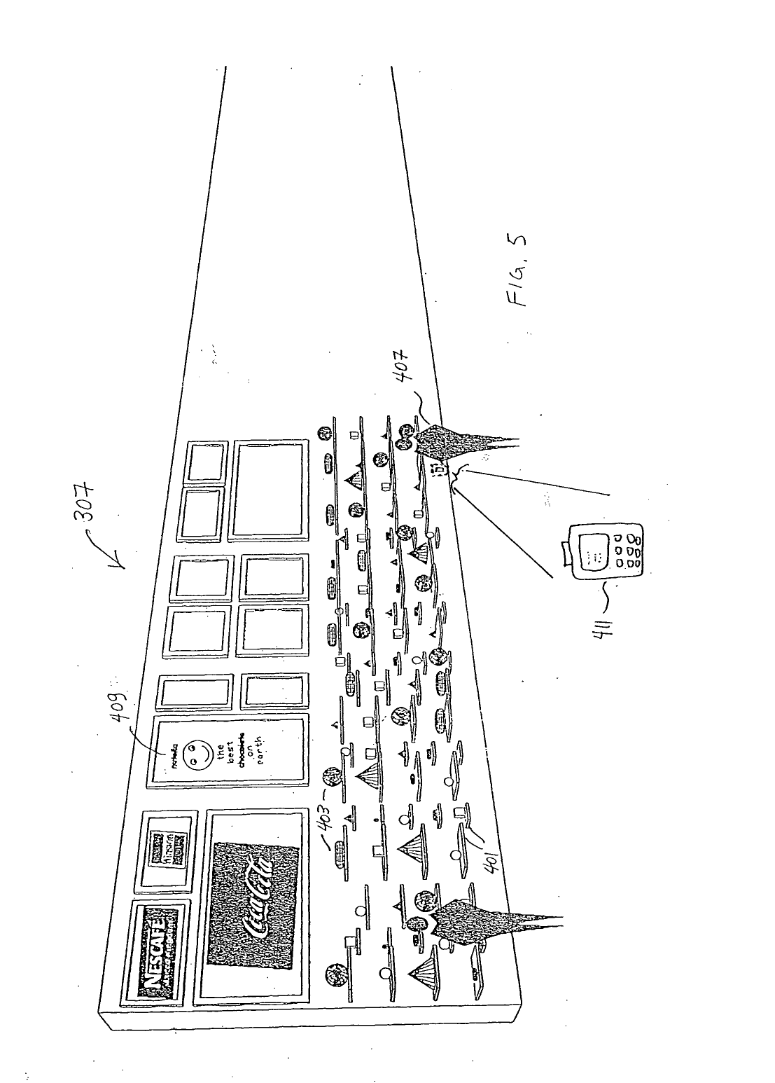

Turning now to the present invention, FIG. 3 shows a floor plan of an embodiment of the present invention, a demo-supermarket 30. Demo-supermarket 30 is divided into two areas, a shopping area 301 and a resource area 305. Near an entrance 309 of demo-supermarket 30 is a service point, for example a service counter 306. In shopping area 301 are multiple display modules 307. FIG. 4 shows in cross section an embodiment of a display module 307 according to the present invention. Display module 307 includes a support element 401, e.g. shelf, to hold a single display item 403 representing an item available for purchase. A detail of a single shelf of display module 307 is shown in FIG. 4a. Since in an embodiment of the present invention a single display item of each kind is displayed, display module 307 has a narrow profile, a horizontal depth less than 50 cm., saving considerable floor space. In an embodiment of the present invention, display module 307 includes a security device 405, e.g. a wire, that secures display item 403, so that a customer 407 may take display item 403 in hand, feel it and view it from all sides, but he is unable to remove display item 403 from its proper place on display module 307. FIG. 5 illustrates, in perspective, a display module 307 in a demo-supermarket 30, according to an embodiment of the present invention. Display module 307 includes two dimensional display screens 409 visible to the shopping customers, for instance, to convey product information. Screens 409 show still images and/or moving images, e.g. video. Customer 407 preferably carries an information storage device 411, preferably including a mechanism for retrieving purchase codes from display items 403 to form a shopping list. Information storage device 411 is preferably electronic, magnetic and/or optical so that the information, e.g. shopping list, is readily entered and rapidly retrieved subsequently at checkout. In an embodiment of the present invention, information storage device 411 is part of a hand-held electronic device. The hand-held electronic device in an embodiment of the present inventions includes a mechanism of wireless communications, preferably a bar code scanner for retrieving product codes.

In another embodiment of the present invention, a customer-operated shopping list assembly system is used to assemble a shopping list. In an embodiment of the present invention, a customer operated shopping list assembly system includes storage for the assembly of shopping lists for all customers 407 at a central location, for example, associated with a main computer situated at service counter 306. Preferably, purchase code and shopping list information associated with a specific customer 407 is transferred to a central location using wireless communications e.g. wireless radio. The “customer-operated shopping list assembly system”, herein refers to any system for creating and storing customer shopping lists and storing quantities for purchase items included in the shopping lists. Customer-operated shopping list assembly systems, according to the present invention, include diverse systems such as stickers printed with purchase codes, bar code scanners, or magnetic media for magnetically recording purchase codes.

Referring back to FIG. 3, of floor plan of demo-supermarket 30, an embodiment of the present invention includes booths 303 that are optionally used for consumable product promotional purposes, e.g. tasting specific foods, smelling perfumes and/or recreational activities. Resource area 305 in demo-supermarket 30 optionally includes in addition to an operations area, e.g., office and a preparation room, other areas for customers' convenience such as rest rooms, baby changing rooms, and checking of coats and parcels.

It is readily seen that resource area 305 of a demo-supermarket is less than 15% of the total floor area required by a demo-supermarket, whereas operations area including service area 103 and checkout area 105 of conventional supermarket 10 combined require at least 25% of the total floor area of conventional supermarket 10. Moreover, as discussed above, resource area 305 of a demo-supermarket, according to an embodiment of the present invention, is devoted to customer convenience as opposed to service area 103 and checkout area 105 of conventional supermarket 10 that are required for operations leaving little space for customer services and recreation.

Other embodiments of the present invention include interior designs suited to the space available or the cost of obtaining rental space. For instance, a demo-supermarket 30 of floor area less than 100 square meters can be designed to include all the items for purchase in a conventional supermarket 10 of more than 400 square meters. The small floor area translates directly into monetary savings in rental cost, and utilities costs.

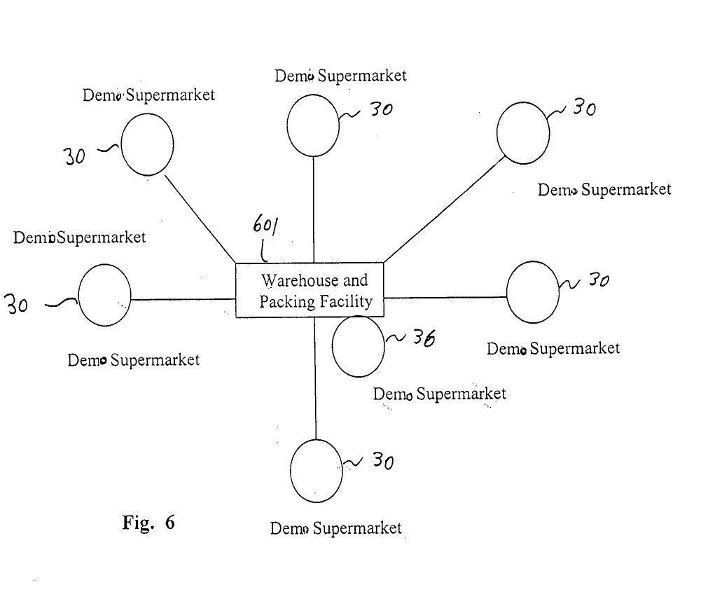

FIG. 6 illustrates a node of a shopping network, according to the present invention. In the embodiment of FIG. 6, a single warehouse and packing facility 601 serves several demo-supermarkets 30. In one embodiment of the present invention, a demo-supermarket 36 is located near the warehouse and packing facility 601. Other demo-supermarkets 30 are more distantly located from warehouse and packing facility 601.

The operation of a shopping system including a demo-supermarket 30, according to the present invention, begins with customer 407 who enters an entrance 309 in demo-supermarket 30. Customer 407 may opt to check her coat and bags and/or use a rest room in resource area 305. Customer 407 may opt at this point to proceed to one or more of booths 303, for instance, to taste a food item and/or to smell a perfume. Alternatively, if customer 407 chooses to begin shopping, she approaches service counter 306. At service counter 306, a service point for a demo-supermarket, customer 407 receives information storage device 411. Customer 407, carrying information storage device 411, proceeds to view display items 403 shown in display modules 307. When customer 407 decides to purchase an item identical with display item 403, customer 407 retrieves a specific purchase code identifying display item 403; the code being stored in the information storage device. Customer 407 enters a number into information storage device 411, indicating a quantity of items identical to display item 403 she wishes to purchase. It is noteworthy that during this novel shopping experience, customer 407 is neither burdened with pushing a shopping cart nor does customer 407 need to maneuver around other customers pushing shopping carts. While shopping, customer 407 is free to take in hand and look at display items 403 from all sides, for instance, to read the products' ingredients. In one embodiment of the present invention, display item 403 is a real item containing food, e.g. breakfast cereal. In this case, since display item 403, is not for sale, the food contained in display item 403 may be available to customer 407 for tasting. In another embodiment of the present invention, for instance, display item 407 is a package of an item for purchase. This is appropriate, for instance, if display item 407 is a package of perishable food items or a food item requiring refrigeration.

Customer 407 has finished shopping, and approaches service counter 306. At service counter 306, customer 407 returns the information storage device 411 and arranges for delivery of the purchased items and payment for the purchase order. Customer 407 exits demo-supermarket 30 unburdened with heavy bags of food and other perishable items and she is free to return to work or recreation.

The shopping list of customer 407 is transferred, preferably by rapid electronics communications, e.g. electronic mail, to a warehouse and packing facility 601 near the requested delivery point of customer 407. Customer 407 may have done shopping for her mother, for instance, who lives in a different city and therefore she requests delivery to her mother's residence. Alternatively, if for instance, customer 407 has shopped in a demo-supermarket 36 located near warehouse and packing facility 601, she may opt to waive delivery and pick up her shopping herself from warehouse and packing facility 601.

In an embodiment of the present invention, demo-supermarket 30 includes a sign outside demo-supermarket 30 indicating the number of customers 407 already inside demo-supermarket 30. A new customer 407 may opt to shop at a later time if the sign indicates that many customers 407 are in the store.

As warehouse and packing facility 601 periodically updates the variety of items available for purchase, display items 403 representing items that are no longer available for purchase are removed from display modules 307 and replaced with new display items 403 representing the new variety in stock.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. While the invention has been described with respect to a limited number of embodiments, it will be appreciated that many variations, modifications and other applications of the invention may be made.

1. A shopping system for consumable items comprising:
(a) at least one display module including a plurality of display items, wherein each of said display items is not itself available for purchase but visually represents a corresponding one of the consumable items available for purchase, wherein purchase codes associate said display items to the respective consumable items, wherein said purchase codes are collected by a customer;
(b) a customer-operated shopping list assembly system operative to assemble a shopping list corresponding to purchase items said customer wishes to purchase and a quantity for each of said purchase items;
(c) a service point that receives said shopping list with delivery instructions from said customer; and
(d) a warehouse and packing facility that stores the consumable items and on receipt of said shopping list from said service point, packs and arranges delivery of the consumable items according to said shopping list and said instructions.

2. The shopping system, according to claim 1, wherein said display module has a horizontal depth of less than 50 cm.

3. The shopping system, according to claim 1, wherein said display item is a sample item substantially identical to said corresponding one of the consumable items available for purchase.

4. The shopping system, according to claim 1, wherein said display item is a replica visually representing said corresponding one of the consumable items available for purchase.

5. The shopping system, according to claim 1, wherein said display item is an original package with at least a portion of the contents removed.

6. The shopping system, according to claim 1, further comprising:
(e) at least one booth for providing a service of a type selected from the group consisting of product promotion and recreation for said customer; and
(f) at least one resource area for providing services to said customer

7. A shopping system for consumable items comprising:
(a) a plurality of display items, wherein each of said display items is not itself available for purchase but visually represents a corresponding one of the consumable items available for purchase, wherein purchase codes associate said display items to the respective consumable items available for purchase;
(b) an information storage device used by customers for retrieving said purchase codes to create respective shopping lists and for giving said shopping lists with delivery instructions to a service point; and
(c) a warehouse and packing facility that stores the consumable items and on receipt of said shopping lists and said instructions from said service point, packs and arranges delivery of the consumable items, according to said customers' respective shopping lists and said instructions.

8. The shopping system, according to claim 7, wherein said information storage device further includes a wireless mechanism for said retrieving.

9. The shopping system, according to claim 7, wherein said information storage device includes a bar code scanner for said retrieving.

10. A display module, in a shopping system, for displaying items to customers comprising:
(a) a plurality of display items for viewing by the customers, wherein each of said display items is not itself available for purchase but visually represents one consumable item available for purchase; and
(b) a security mechanism that connects said display items to the display module permitting the customers to handle said display items but preventing the customers from removing said items from the display module.

11. The display module, according to claim 10, further comprising:
(c) at least one display screen for conveying information to the customers.

12. The display module, according to claim 10, wherein said security mechanism includes a wire for said preventing.

13. A method for selling consumable items, comprising the steps of:
(a) showing display items to a customer, wherein each of said display items is not itself available for purchase but visually represents a corresponding one of the consumable items available for purchase said display items having purchase codes associated respectively with the consumable items;
(b) receiving a shopping list and delivery instructions from said customer, said shopping list being created by collecting a plurality of said purchase codes from a plurality of the consumable items;
(c) transferring said shopping list and said instructions to a warehouse and packing facility including the consumable items; and
(d) packing purchased items according to said shopping list for delivery according to said instructions.

14. The method, according to claim 13, wherein said collecting is performed using a bar code scanner.

15. The method, according to claim 13, further comprising the steps of:
(e) receiving a new variety of the consumable items into said warehouse and packing facility; and
(f) updating said display items to represent said new variety.
